(19) United States
(12) Patent Application Publication
(10) Pub. No.: US 2024/0129896 A1
(43) Pub. Date: Apr. 18, 2024

(54) METHODS AND SYSTEMS FOR PROVIDING COMMUNICATION BETWEEN A MULTI-SIM USER EQUIPMENT AND NETWORKS

(71) Applicant: SAMSUNG ELECTRONICS CO., LTD., SUWON-SI, GYEONGGI-DO (KR)

(72) Inventors: Ramkumar Thirumalli Sureshsah, Bangalore (IN); Mohanraja Balasubramaniam, Bangalore (IN); Debabrata Das, Bangalore (IN)

(21) Appl. No.: 18/554,706

(22) PCT Filed: Apr. 8, 2022
(86) PCT No.: PCT/KR2022/005126

§ 371 Date: Oct. 10, 2023

(30) Foreign Application Priority Data
Apr. 9, 2021 (IN) 202141016818

(51) Int. Cl. H04W 68/02; H04W 8/18

(52) U.S. Cl. CPC H04W 68/02; H04W 8/183; H04W 88/06

(57) ABSTRACT

The present disclosure discloses methods and systems for providing communication between a multiple subscriber identity module (SIM) user equipment (UE) and multiple networks. The method may comprise notifying at least one second SIM to hold decoding of paging data associated with a paging channel monitoring request, the at least one second SIM registered with at least one second network of the plurality of networks. The method may comprise receiving an indication associated with the paging channel monitoring request from the at least one second network. The method may comprise transmitting the indication associated with paging channel monitoring request, to a first SIM registered with a first network of the plurality of networks, the indication associated with the paging channel monitoring request meant for at least one second SIM and allowing the first SIM to instruct the at least one second SIM to resume decoding of the paging data.

### FIELD OF THE INVENTION

The present disclosure generally relates to wireless communication. In particular, the present disclosure relates to methods and systems for providing communication between a multiple subscriber identity module (multi-SIM) user equipment (UE) and a plurality of networks.

### BACKGROUND

In a wireless communication system, an electronic device (for example, a user equipment (UE)) may access a wireless communication network (e.g., for data communication services, voice communication services, etc.). To provide the electronic device with a communication service, an authentication process may be performed where a subscriber identity module (SIM) card may be inserted into the electronic device (e.g., and authentication may proceed between the electronic device and a server of a mobile network operator (MNO)). In some cases, an electronic device supporting two SIMs may be referred to as a dual-SIM electronic device, and an electronic device supporting multiple SIMs may be referred to as a multi-SIM electronic device. A dual-SIM or multi-SIM electronic device may support multiple SIMs (e.g., each of which may be associated with a different subscription).

In many cases, multi-SIM devices may experience interruptions on one service (e.g., a service associate with a first SIM of the multi-SIM device) in order to manage operations of another service (e.g., another service associated with a second SIM of the multi-SIM device). For instance, when a protocol stack corresponding to one SIM card is communicating with the network, a protocol stack of other SIMs may not communicate with the network (e.g., nor perform any activity). Further, in some examples, activity on SIM card (e.g., on one protocol stack) may be intermittently interrupted by another protocol stack (e.g., such as an idle mode protocol stack to monitor a paging channel), which may be inefficient (e.g., as paging messages may or may not be present, as paging messages may not be of higher priority than the activity on the first SIM card, etc.). Accordingly, there is a need in the art for improved protocols and processes (e.g., for operation of multi-SIM devices within co-existing networks) to improve the quality and throughput of wireless communication systems.

### SUMMARY

This summary is provided to introduce a selection of concepts that are further described in the detailed description of the invention. This summary is not intended to identify key or essential inventive concepts of the invention, nor is it intended for determining the scope of the invention

In an embodiment of the present disclosure, a method for providing communication between a multiple subscriber identity module (multi-SIM) user equipment (UE) and a plurality of networks, is described. The method may comprise notifying at least one second SIM to hold decoding of paging data associated with a paging channel monitoring request, wherein the at least one second SIM is registered with at least one second network of the plurality of networks. The method may further comprise receiving an indication associated with the paging channel monitoring request from the at least one second network. The method may also comprise transmitting the indication associated with paging channel monitoring request to a first SIM registered with a first network of the plurality of networks, wherein the indication associated with the paging channel monitoring request is meant for the at least one second SIM and allowing the first SIM to instruct the at least one second SIM to resume decoding of the paging data.

In another embodiment, the at least one second SIM holds the decoding of paging data, upon completion of a mobile terminating procedure associated with the paging data.

In yet another embodiment, prior to notifying the at least one second SIM to hold decoding of the paging data, the method further comprises: registering the first SIM and the at least one second SIM, receiving a request from the first SIM to provide the indication associated with the paging channel monitoring request meant for the at least one second SIM, and registering the first SIM in a database to indicate the paging channel monitoring request meant for the at least one second SIM.

In another embodiment of the present disclosure, a method for providing communication between a multi-SIM UE and a plurality of networks, is disclosed. The method may comprise receiving a notification of priority activity from at least one second SIM network of the plurality of networks, wherein the at least one second network is associated with at least one second SIM. The method may further comprise allowing a first network to hold allocation of physical channel resources to the first SIM based on the notification, wherein the first network is associated with a first SIM. The method may also comprise receiving a notification of completion of the priority activity from the at least one second network and allowing the first network to resume allocation of physical channel resources to the first SIM upon receiving the notification of completion of the priority activity.

In yet another embodiment of the present disclosure, a system for providing communication between a multi-SIM UE and a plurality of networks, is disclosed. The network entity may comprise a memory and a processor coupled to the memory. The processor may be configured to: notify at least one second SIM to hold decoding of paging data associated with a paging channel monitoring request, wherein the at least one second SIM is registered with at least one second network of the plurality of networks, receive an indication associated with the paging channel monitoring request from the at least one second network, transmit the indication associated with the paging channel monitoring request, to a first SIM registered with a first network of the plurality of networks, wherein the indication associated with the paging channel monitoring request is meant for the at least one second SIM and allow the first SIM to instruct the at least one second SIM to resume decoding of the paging data.

In another embodiment, prior to allowing the first network to hold allocation of physical channel resources, the method further comprises: transmitting the notification to the first network of the plurality of networks.

In yet another embodiment, prior to receiving the notification of the priority activity from at least one second network, the method further comprises: registering the first SIM and the at least one second SIM, receiving a subscription request from the first network associated with the first SIM to provide the notification of priority activity of the at least one second SIM, and accepting the subscription request.

In still another embodiment of the present disclosure, a system for providing communication between a multi-SIM UE and a plurality of networks, is disclosed. The network entity may comprise a memory and a processor coupled to the memory. The processor may be configured to: receive a notification of priority activity from at least one second SIM network of the plurality of networks, wherein the at least one second network is associated with at least one second SIM, allow a first network to hold allocation of physical channel resources to the first SIM based on the notification, wherein the first network is associated with a first SIM, receive a notification of completion of the priority activity from the at least one second network and allow the first network to resume allocation of physical channel resources to the first SIM upon receiving the notification of completion of the priority activity.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings, in which like characters may represent like parts throughout the drawings.

FIG. 1 illustrates interfaces between multiple operator gNodeBs (gNBs) and access network coordinator (ANC), in accordance with one or more aspects of the present disclosure.

FIG. 2 illustrates a block diagram of an ANC, in accordance with one or more aspects of the present disclosure.

FIG. 2(a) depicts registration manger (RM) database management after ANC registration is completed, in accordance with one or more aspects of the present disclosure.

FIG. 2(b) depicts subscription Manager (SM) Database management after completion of subscription procedure, in accordance with one or more aspects of the present disclosure.

FIG. 3 illustrates network registration and ANC Registration procedure between user equipment (UE), gNBs and ANC, in accordance with one or more aspects of the present disclosure.

FIG. 4 illustrates a flow chart depicting a method for providing communication between a multi subscriber identity module (multi-SIM) user equipment (UE) and a plurality of networks, in accordance with one or more aspects of the present disclosure.

FIG. 5 depicts the coordination between UE, gNB and ANC for an end-to-end paging coordination procedure, in accordance with one or more aspects of the present disclosure.

FIG. 6 illustrates depicting a method for providing communication between a multi-SIM UE and a plurality of networks, in accordance with one or more aspects of the present disclosure.

FIG. 7 illustrates an end-to-end idle mode protocol stack's high priority activity handling between UE, gNB and ANC, according to one or more aspects of the present disclosure.

FIG. 8 illustrates a block diagram of a system providing communication between a multi-SIM UE and a plurality of networks, in accordance with one or more aspects of the present disclosure.

Further, skilled artisans will appreciate that elements in the drawings are illustrated for simplicity and may not have been necessarily drawn to scale. For example, flow charts illustrate methods in terms of the some prominent steps involved to help to improve understanding of aspects of the present invention. Furthermore, in terms of the construction of a device/entity, one or more components of a device/entity may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

In some cases, multiple subscriber identity module (multi-SIM) user equipment (UEs) can be broadly classified into multi SIM multi standby (MSMS) UEs and multi SIM multi active (MSMA) UEs. In both MSMS UEs and MSMA UEs, each SIM may be associated with one protocol stack. For instance, MSMS UEs may use a single radio frequency integrated circuit (RFIC) to reduce the cost. Protocol stacks corresponding to each SIM card communicate with associated networks using a same RFIC (e.g., in a time multiplexed manner). When a protocol stack corresponding to one SIM card is communicating with the network, a protocol stack of other SIMs may not communicate with the network (e.g., nor perform any activity). However, in case of MSMA UEs, a protocol stack corresponding to each SIM card may have a dedicated RFIC for communicating with the network, which increases cost of the device and results in faster battery drainage. Some versions of MSMS UE may implement multiple receiver (Rx) RFIC chains and one transmitter (Tx) RFIC chain (e.g., which strive to enable MSMA functionality by time sharing). However, simultaneous reception across multiple Rx may be restricted due to limited frequency band combination support. Further, simultaneous usage of multiple Rx chains may increase battery drainage (e.g., in comparison with MSMS UEs). Hence, MSMS UEs with a single Rx chain and a single Tx chain may be preferred in some scenarios. For instance, multi-SIM capable UEs available in the market may be predominantly MSMS UEs built with two SIM capability.

As there is no standardized mechanism to prioritize usage of RFIC for activities in MSMS UEs, protocol stack design and implementation may also be unstandardized (e.g., design and implementation may be UE vendor specific). In MSMS UEs, in some cases, active packet switching (PS) activity on one protocol stack may be intermittently interrupted by other idle mode protocol stack(s). The reason being, idle mode protocol stack(s) may use RFIC to monitor a paging channel, to perform measurements on each discontinuous reception (DRX) cycle configured by network, etc. Also, the idle mode protocol stack(s) need RFIC to initiate high priority signaling to the network for registration, call, short message services (SMS) or supplementary services (SS), etc. Such interruption on PS activity may be referred as blackout. Depending on the number of the SIMs a MSMS UE has in idle mode, there may be an increase in blackout potential for a PS connected mode SIM. Such blackout may decrease system performance, for example, as there may be a drop in throughput proportionate to such blackout occurrences.

In addition, the physical channel resources (PCR) allocation by a network to a PS connected SIM may be inefficient (e.g., or PCR allocated by the network to a PS connected SIM may be wasted). For instance, as the network is not aware of radio frequency (RF) interruption on a PS connected stack, the network may continue to allocate resources (e.g., inefficiently). Some attempts to solve this problem may include making a PS connected stack indicate to the network to end the session when there is a high priority operation on other protocol stack(s). However, such methods may lead to increased resource overhead, such as increased signaling load between a UE and a network when there are back-to-back high priority activities happening on the other stack(s). Moreover, connection re-establishment may then be necessary to restore the PS connection. In some cases, it has been proposed to send a new message from a UE to an access network, from a PS connected protocol stack, notifying the start and end of current stack inactivity due to high priority operation on the other stack(s). Further, it has been proposed to send a new non access stratum (NAS) signaling message to indicate about the inactivity period to stop pushing data from core network during such an indicated inactivity period. However, such conventional proposals increase the signaling load between a UE and a network. Further, conventional proposals do not sufficiently reduce blackouts caused due to paging decoding of idle mode SIM(s).

Accordingly, existing arts have attempted to solve problems described above by introducing a new message or reusing the existing message to indicate the inactivity of a PS connected stack. Such sharing of inactivity information increases over the air signaling load between the UE and network (e.g., and interruption on PS activity is still not avoided). As such, there is a need in the art for techniques for improved reduction of blackouts caused due to paging occasion monitoring in idle mode SIM(s), for reduction of resource wastage pertaining to PCR allocated by the network for a PS connected stack, etc. (e.g., without requiring unnecessary signaling overhead between UEs and a network).

According to aspects of the present disclosure, an Access Network Coordinator (ANC) may be accessed by Radio Access Networks (RANs) of same or different network operator(s) to share information (e.g., information of registered multi-SIM capable UEs). Further, the present disclosure describes example protocol and procedures (e.g., of an ANC) that may achieve the reduction of paging occasion monitoring in idle mode SIM of MSMS UEs, in addition to making a network aware of other SIM high priority signaling activity (e.g., for avoiding resource scheduling during blackout on a PS connected stack). Based on the information available via the ANC, the network may notify a UE to start monitoring intended paging occasions only when there is a mobile terminated (MT) paging.

For instance, according to the techniques described herein, an ANC may coordinate between the RANs of same or different operators to share paging information, as well as allow RANs to subscribe to get notification of ongoing activity (e.g., of ongoing activity on specific SIMs of MSMS devices). Further, an ANC may maintain the states of registered UEs based on the ongoing activities updated by respective RANs, in addition to managing the information of registered UEs (e.g., using a unique identifier (ID) assigned by the respective MSMS UEs).

For the purpose of promoting an understanding of the principles of the invention, specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

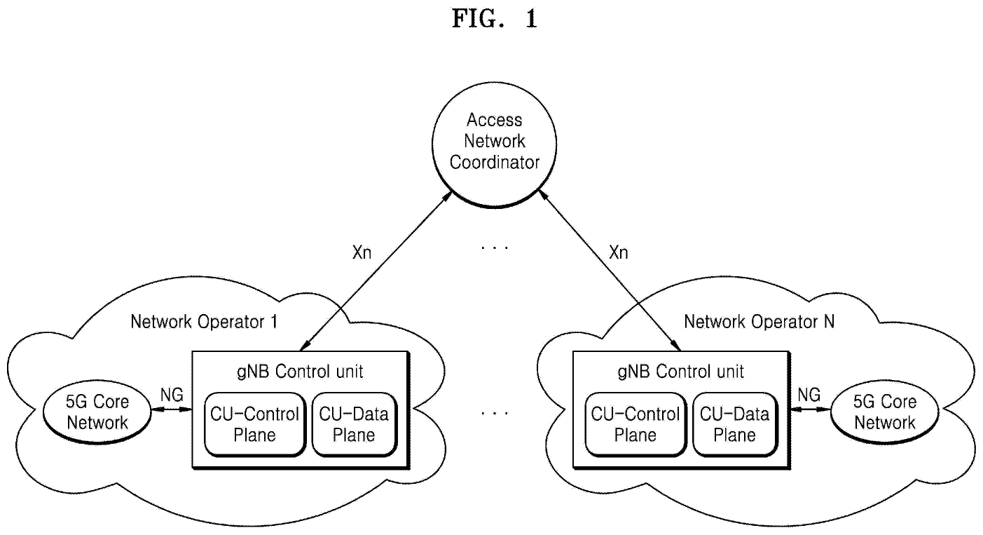

FIG. 1 depicts example interfaces between multiple operator gNodeBs (gNBs) and ANC, in accordance with one or more aspects of the present disclosure. In some examples, the proposed network architecture may be implemented for systems such as, for example, 5G or Beyond 5G networks (e.g., as it's effortless to implement with flexible RAN such as FlexRAN), legacy networks, etc. In some examples, the ANC may be located between gNBs of different network operators (e.g., as shown in FIG. 1). In some cases, a gNBs control unit may reuse Xn interfaces to access the ANC. For example, Xn interfaces may be used (e.g., by 3GPP systems) for the communication between gNBs, and such existing Xn interfaces may be used by the ANC.

Various embodiments of the present disclosure will be described below in detail.

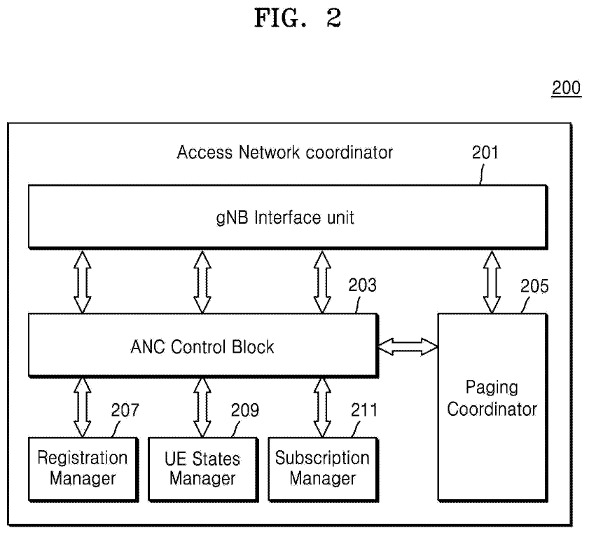

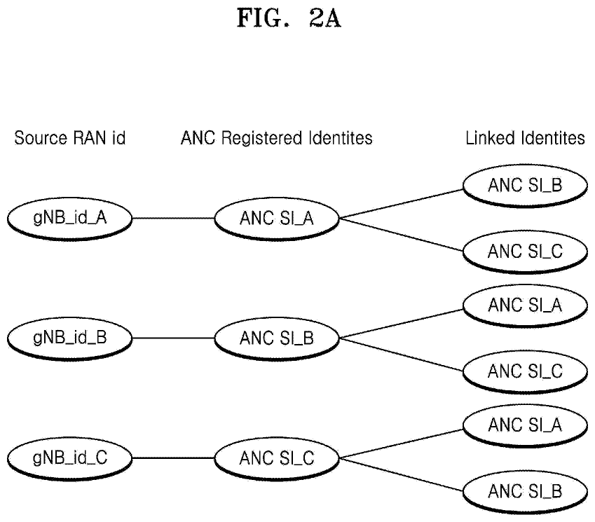

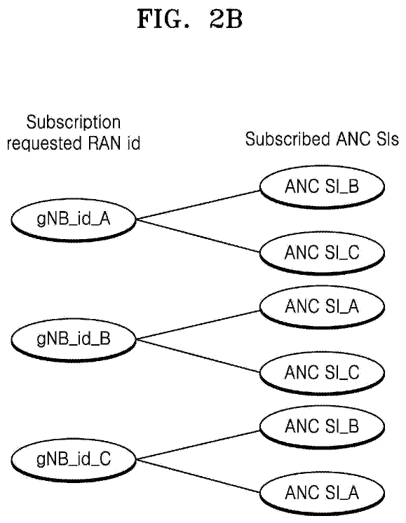

FIG. 2 illustrates a block diagram of an ANC (200), in accordance with example embodiments of the present disclosure. The ANC (200) may include a gNB interface unit (201), ANC control block (CB) (203), a paging coordinator (PC) (205), a registration manger (RM) database (207), a UE state manager (209) and a subscription Manager (SM) (211). In one or more embodiments, the gNB interface unit (201) may translate communication (e.g., through a Xn interface from a gNB control unit) to the ANC CB (203) or to a PC (205). The ANC CB (203) may be a processing unit in the ANC (200), for example, which may process ANC (200) registration requests from gNBs for UEs that are served under its umbrella.

For the sake of discussion of FIGS. 2-7, a triple SIM triple standby (TSTS) UE may be considered that helps in linking defined ANC (200) procedures with its functionalities to achieve the end result. For instance, in an example, SIM A, SIM B and SIM C may belong to a TSTS UE and may be served by gNB A, gNB B and gNB C, respectively. A UE may generally include any computing device, such as a personal computer, laptop computer, mainframe computer, palmtop computer, personal assistant, mobile device, or any other suitable processing apparatus.

A subscriber identification module (SIM) may be an integrated circuit that securely stores an international mobile subscriber identity (IMSI) and the related key used to identify and authenticate a wireless device. SIM may also contain a unique serial number (e.g., an integrated circuit card ID (ICCID)), security authentication and ciphering information, temporary information related to the local network, a list of the services, a personal identification number (PIN), and a personal unblocking code (PUK) for PIN unlocking. In some cases, SIM may be a circuit embedded in a removable plastic card.

UEs may be identified in the ANC (200) through a unique identity. In some examples, this unique identity may be referred to as an Access Network Coordinator Subscriber Identity (ANCSI). This identity is specific to one SIM of a MSMS UE. The ANCSI may be used by the gNB for SIM Specific transactions that happens with ANC (200). The ANCSI may be generated by the UE based on (e.g., with combination of) an international mobile subscriber identity (IMSI) and an international mobile equipment identity (IMEI). Generally, it should be noted that the ANCSI may be generated by any other method known to a person skilled in the art. ANC CB (203) updates a unique ID of UE (i.e., the ANCSI) to the RM database on completion of ANC (200) registration.

FIG. 2(a) depicts RM database (207) management after ANC (200) registration is completed, and FIG. 2(b) depicts SM database (211) management after completion of subscription procedure. The RM database (207) maintains the information about the SIMs that are mapped to same device. The SM (211) maintains a mapping table about the gNBs that are enrolled to receive notifications, upon state change on specific ANCSIs. For example, gNB_id_A, gNB_id_B, and gNB_id_C are examples of the gNB IDs that may have initiated ANC (200) registration for SIM A, SIM B, and SIM C, respectively. ANCSI_A, ANCSI_B and ANCSI_C are the ANCSIs assigned for SIM A, SIM B and SIM C, respectively.

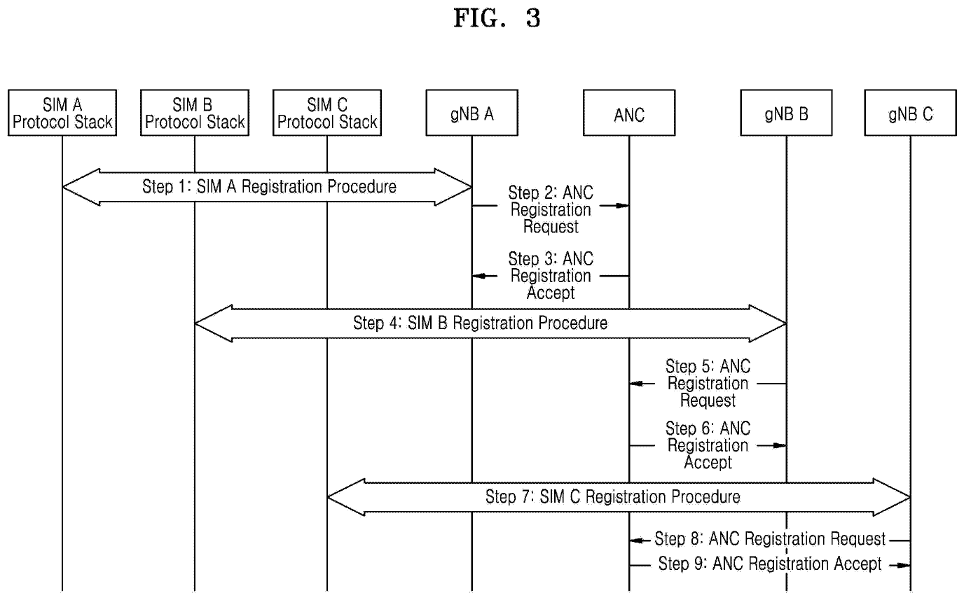

FIG. 3 depicts network registration procedures and ANC registration procedures between a UE (e.g., a multi-SIM UE including SIM A, SIM B and SIM C), gNBs (e.g., gNB A, gNB B and gNB C) and ANC, in accordance with techniques described herein. The purpose of registration with ANC (200) for a SIM is to make ANC (200) aware of the SIMs that are from same MSMS (e.g., TSTS) UE. As part of the UE registration to the network (e.g., upon power-on, due to change of the registration area, etc.), the UE informs its network with information used by gNB to perform ANC (200) registration. Such information includes, for example, a unique identity (e.g., ANCSI) of the SIM that's initiating the registration with network, as well as unique identities (e.g., ANC SI's) of other SIM(s) that are present in MSMS UE (e.g., which may be referred to as linked-ANCSIs).

Upon successful completion of UE registration with the network, a gNB may trigger the ANC (200) registration procedure with information including: a parent-ANCSI (e.g., which is the ANSCI of the SIM which had completed the network registration), as well as the linked-ANSCI(s) of the MSMS UE.

Upon receiving of the ANC (200) registration request, ANC (200) updates RM (e.g., RM database (207)) with the information received in ANC (200) registration request corresponding to the gNB identity. ANC (200) ends the registration procedure by sending ANC-Registration accept message to gNB.

As shown in FIG. 3, at step 1, a registration procedure for SIM A is completed. gNB A becomes aware of the parent ANCSI (e.g., SIM A ANCSI) and linked-ANCSIs (e.g., SIM B ANCSI and SIM C ANCSI). gNB A stores SIM A ANCSI linking it to SIM A's permanent identity. At step 2, gNB A initiates an ANC (200) registration request to update parent ANCSI and linked-ANCSF s to the ANC. Upon receiving the ANC (200) registration request, ANC (200) updates the RM database (207) and at step 3, ANC (200) responds back with ANC (200) Registration Accept to gNB A.

Similarly, from step 4 to step 6 and from step 7 to step 9, SIM B and SIM C registration procedures and corresponding ANC (200) registration may be completed, respectively. The ANC CB (203) updates unique ID of all the SIMs in the UE (e.g., SIM A, SIM B and SIM C) to a RM database (207) on completion of ANC (200) registration.

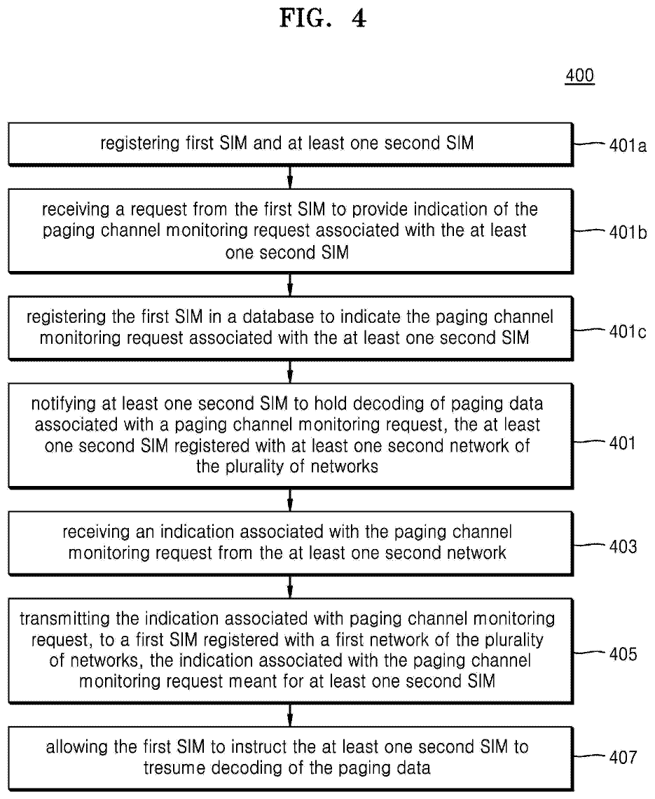

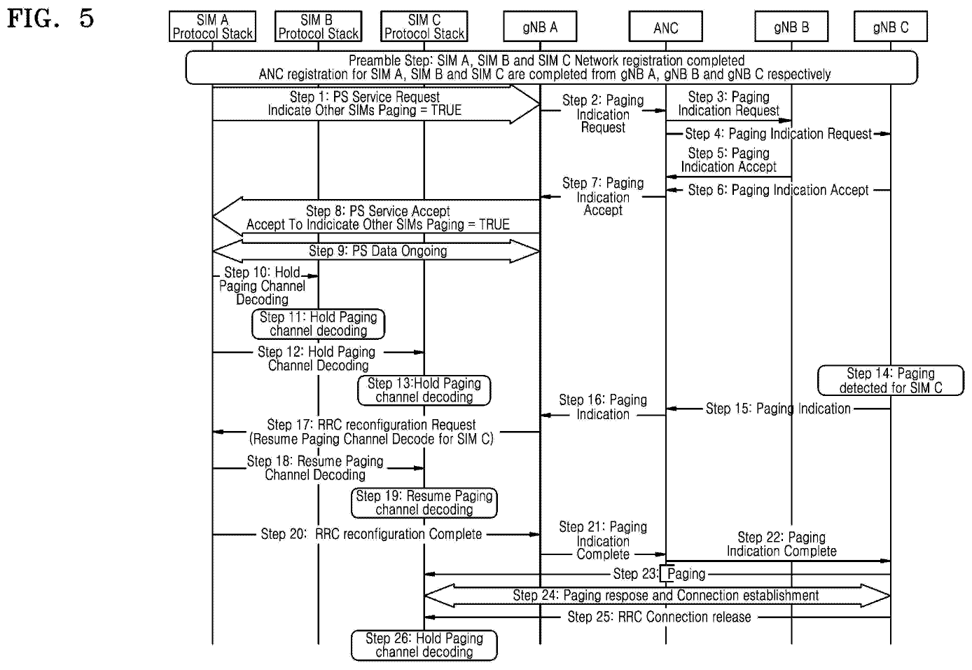

FIG. 4 illustrates a flow chart depicting an example method 400 for providing communication between a multi-SIM UE and a plurality of networks, in accordance with one or more aspects of the present disclosure. In some cases, the method 400 may be referred to as an end-to-end paging coordination procedure (e.g., aspects of which are described in more detail herein, for example, with reference to FIG. 5). In one or more embodiments, the PC (205) helps to manage paging coordination procedures between gNBs for the SIMs that are ANC (200) registered.

As shown in FIG. 4, at step 401, the method 400 comprises notifying at least one second SIM (e.g., SIM B and/or SIM C) to hold decoding (e.g., stop decoding, cease/pause decoding, cancel future decoding, etc.) of paging data associated with a paging channel monitoring request, where the at least one second SIM (e.g., SIM B and/or SIM C) is registered with at least one second network (e.g., gNB B and/or gNB C) of the plurality of networks. At step 401, in one example embodiment, the notification for the at least one second SIM to hold decoding of paging data associated with the paging channel monitoring request implicitly indicates (e.g., is implicitly understood by the at least one second SIM) to hold the decoding of paging data unless otherwise notified by the first SIM. In an alternate embodiment, the at least one SIM may be notified by the ANC (200) to again hold the decoding of the paging data.

In some aspects, prior to notifying the at least one second SIM to hold the decoding of the paging data, at step 401a, a first SIM (e.g., SIM A) and the at least one second SIM may be registered with the ANC (200) (e.g., as described in more detail herein, for example, with reference to FIG. 3). Further, prior to step 401, the method 400 may include, at step 401b, receiving a request from the first SIM to provide indication of the paging channel monitoring request associated with the at least one second SIM. In some aspects, at step 401c, the method 400 may further include registering the first SIM in a database (e.g., to indicate the paging channel monitoring request associated with the at least one second SIM). In some aspects, registration of the first SIM in the database, and indication of the paging channel monitoring request associated with the at least one second SIM, may notify the MSMS UEs about paging intended to one of the idle mode SIMs (e.g., without monitoring its paging channel). Paging procedure coordination may include at least a two step process. For instance, firstly, a gNB serving an idle mode SIM may accept a paging indication request from a gNB serving a PS connected SIM. Secondly, on reception of paging from a Core Network intended for the idle mode SIM, the serving gNB of the idle mode SIM may indicate to ANC (200) about the arrival of paging intended for the idle mode SIM, and ANC (200) may propagate such information to the gNB serving the PS connected SIM.

At step 403, the method 400 comprises receiving an indication associated with the paging channel monitoring request from the at least one second network. Thereafter, at step 405, the method 400 comprises transmitting the indication associated with paging channel monitoring request to a first SIM registered with a first network of the plurality of networks (e.g., the indication associated with the paging channel monitoring request meant for, configured for, generated for, etc., the at least one second SIM). Thereafter, at step 407, the method comprises allowing the first SIM to instruct the at least one second SIM to resume decoding of the paging data. After the decoding of the paging data is completed, the at least one second SIM completes the mobile terminating procedure associated with the paging data and again starts holding the decoding of paging data (e.g., delaying the decoding of paging data until the first SIM instructs the second SIM to again resume decoding of paging data, etc.).

FIG. 5 depicts the coordination between UE, gNB and ANC (200) for the end-to-end paging coordination procedure. As shown in FIG. 5 (e.g., at the preamble step), SIM A, SIM B and SIM C registration procedures and corresponding ANC (200) registration procedures from respective gNBs may be already completed (e.g., prior to step 1 of FIG. 5). In some aspects, the preamble step of FIG. 5 may refer to, or include aspects of, step 401a of FIG. 4.

At step 1, SIM A initiates a PS Service Request to gNB A, including a request to indicate the arrival of intended paging messages of SIM B and SIM C. At step 2, gNB A triggers a Paging Indication Request with SIM B and SIM C ANCSIs to ANC (200). On receiving the Paging Indicate Request message from gNB A, ANC (200) identifies the gNBs corresponding to ANCSIs of SIM B and SIM C, and ANC (200) triggers a Paging Indication Request to gNB B and gNB C (e.g., aspects of which are shown in step 3 and step 4, respectively). At Step 5 and Step 6, a Paging Indication Accept is triggered from gNB B and gNB C, respectively (e.g., after ensuring that SIM B and SIM C are served by gNB B and gNB C, respectively). At Step 7, ANC (200) triggers a Paging Indication Accept to gNB A, based on the acceptance from gNB B and gNB C. At Step 8, gNB A triggers a PS Service Accept acknowledging the acceptance to indicate arrival of intended paging messages of SIM B and SIM C to SIM A. At Step 9, PS Data activity is ongoing. In some cases, one or more aspects of steps 1-9 may correspond to steps 401b-401c of FIG. 4.

At Step 10 and Step 12, SIM A indicates to SIM B and SIM C, respectively, to hold the paging channel decoding. At Step 11 and Step 13, SIM B and SIM C holds the paging channel decoding, as the arrival of intended paging messages to SIM B and SIM C will be indicated by SIM A, based on the agreement with the network. As described herein, holding paging channel decoding may refer to SIM B and SIM C cancelling paging channel decoding, pausing paging channel decoding, delaying paging channel decoding, etc. Further, holding paging channel decoding by SIM B and SIM C may include such examples until the arrival of intended paging messages to SIM B and SIM C is indicated by SIM A. For instance, SIM B and SIM C may not decode the paging channel (e.g., may not monitor the paging channel, may receive paging channel messages and store messages in memory while delaying the decoding of the messages, etc.), until SIM A indicates SIM B and SIM C are to resume paging channel decoding. In some cases, one or more aspects of steps 10-13 may correspond to steps 401-403 of FIG. 4.

At Step 14, gNB C receives the paging message intended to SIM C from its Core Network. At Step 15, a Paging Indication message is propagated to ANC (200) with ANCSI of the paged SIM (e.g., the ANCSI of SIM C). At Step 16, ANC (200) identifies gNB A as the Parent ANCSI of the paged SIM's ANCSI (e.g., gNB A serves the ANCSI of SIM A, the parent ANCSI of linked-ANCSI's of SIM B and the paged SIM C), and ANC (200) triggers the Paging Indication message to gNB A. At Step 17, gNB A initiates RRC Reconfiguration Request message to SIM A indicating to resume paging channel decode for SIM C. At Step 18, SIM A requests SIM C to resume paging channel decoding. At Step 19, SIM C resumes paging channel decoding and waits for Paging. At Step 20, RRC reconfiguration complete message is triggered to gNB A. At Step 21 and Step 22, paging indication complete message is propagated to gNB C through ANC (200). In some cases, one or more aspects of steps 14-22 may correspond to step 405 of FIG. 4.

At Step 23, gNB C multicasts the paging message intended to SIM C. At step 24, SIM C successfully receives paging from gNB C, and SIM C further responds back with a paging response message and establishes the connection successfully. At step 25, the intended mobile terminating activity is completed and gNB C initiates RRC connection release. In some cases, one or more aspects of steps 23-25 may correspond to step 407 of FIG. 4. At step 26, upon reception of RRC connection release, SIM C holds the paging channel decoding implicitly. That is, in some examples, after reception of RRC connection release from gNB, SIM C may again hold paging channel decoding automatically (e.g., implicitly, or without explicit indication to do so via any received signalling). Such holding of the paging channel decoding may persist, in some cases, until another indication to resume paging channel decoding is received from SIM A (e.g., until steps 14-19 are repeated for a subsequent occurrence).

As such, there is only limited interruption to the PS connected mode SIM (e.g., to SIM A, in the example described with reference to FIG. 5), as the idle mode SIM(s) need to monitor paging channel only after the indication of intended paging reception. Accordingly, the blackout duration is reduced, and the reduction in blackout duration further improves (e.g., increases) throughput performance.

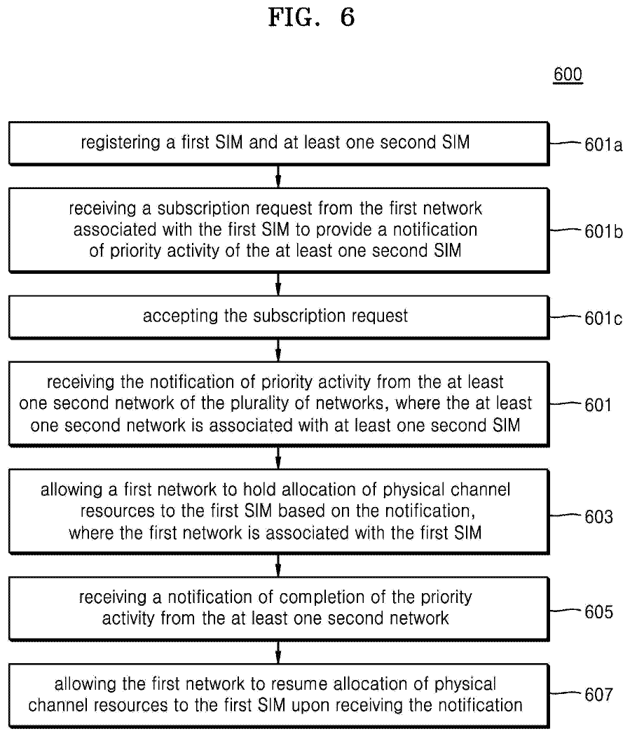

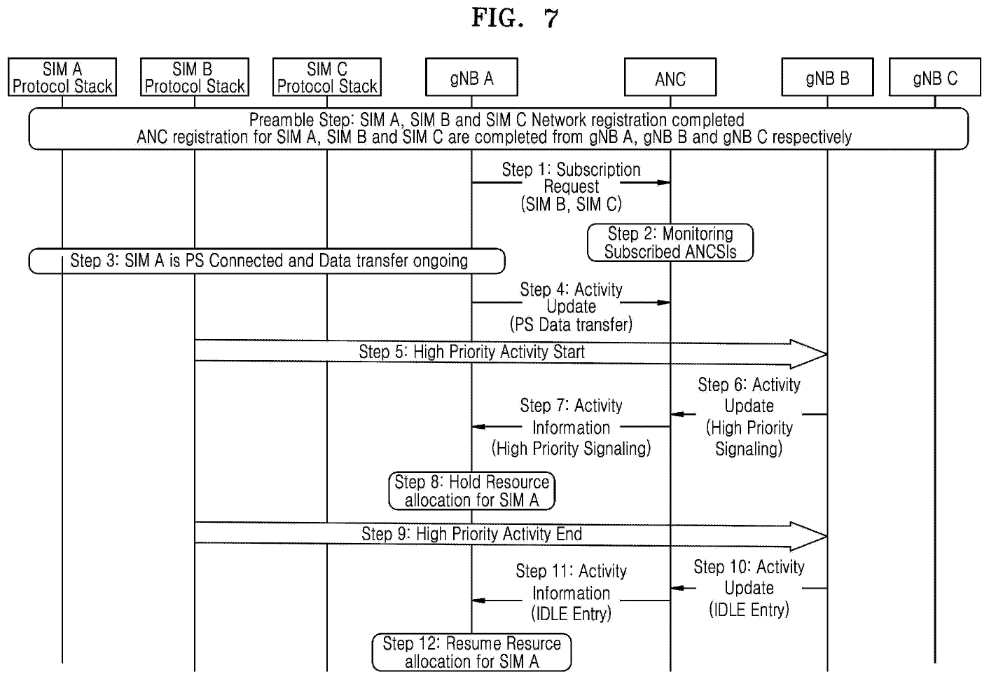

FIG. 6 illustrates a flow chart depicting an example method 600 for providing communication between a multi-SIM UE and a plurality of networks, in accordance with one or more aspects of the present disclosure. In some cases, the method 600 may be referred to as an end-to-end idle mode protocol stack's high priority activity handling between UE, gNB and ANC (e.g., as further described herein, for example, with reference to FIG. 7).

As shown in FIG. 6, at step 601, the method 600 comprises receiving a notification of priority activity from at least one second network (e.g., gNB B, gNB C) of a plurality of networks, the at least one second network associated with at least one second SIM (e.g., SIMB, SIMC). In some aspects, prior step 601 (e.g., at step 601a), a first SIM (e.g., SIMA) and the at least one second SIM are registered with the ANC (200) (e.g., in accordance one or more aspects described with reference to FIG. 3).

Further, prior to step 601, the method 600 comprises, at step 601b, receiving a subscription request from the first network associated with the first SIM to provide the notification of priority activity of the at least one second SIM. Further, prior to step 601, the method 600 further includes, at step 601c, accepting the subscription request. In one or more embodiments, the priority activity may include activities such as registration to new network cell, handover, call, video call etc. This process may be referred to as priority activity update procedure. The priority activity update procedure helps the ANC (200) to be aware of ongoing activities in the MSMS (e.g., TSTS) UEs. These SIM specific activities may be updated to ANC (200) through serving gNBs of MSMS UEs, with reference to ANCSI of the SIM. This information is indicated from gNB to ANC (200) (e.g., using an Activity Update message). Based on the ongoing activity, the ANC (200) updates the UE States Manager (209). To receive the priority activity update, the first network (e.g., gNB A) sends a subscription request to provide the notification of priority activity of the at least one second SIM. This subscription request helps serving gNBs to be notified about ongoing activities on the other SIM(s) available in MSMS UEs that are not served by this gNB.

In one example, gNB A, gNB B, gNB C may serve SIM A, SIM B and SIM C, respectively, of a TSTS UE. gNB A may subscribe to get notified for the activities ongoing on SIM B and SIM C by triggering a subscription request to ANC (200) with ANCSIs of SIM B and SIM C. The ANC (200) updates the SM database (211) and monitors activity updates from gNB B for SIM B's ANCSI, as well as activity updates from gNB C for SIM C's ANCSI. The ANC (200) triggers priority activity information notification to gNB B, upon change of ongoing activity corresponding to SIM B's ANCSI. Similarly, the ANC (200) triggers priority activity information notification to gNB C, upon change of ongoing activity corresponding to SIM C's ANCSI. Accordingly, the ANC CB (203) may process subscription requests from gNB and updates subscription information to the SM database (211) corresponding to unique ID of ANC (200) registered SIM. Further, ANC CB (203) may process priority activity update from gNB corresponding to ANC (200) registered UE. Also, the ANC CB (203) updates the state of the UE corresponding to the activity that is ongoing to UE State Manager (209). In some examples, the ANC CB (203) handles communication within (e.g., within all the components) of the ANC (200).

Further, UE States Manager (209) maintains states of the ANC (200) registered UEs, corresponding to its ANCSI. In some aspects, the states are the direct mapping to the activity that is ongoing in a SIM. The state information may be updated to ANC (200) by the respective gNB that is serving the SIM.

At step 603, the method 600 comprises allowing a first network to hold allocation of physical channel resources to the first SIM based on the notification (e.g., where the first network is associated with a first SIM). Prior to step 603, at step 603a, the ANC (200) may transmit the notification to the first network of the plurality of networks. Thereafter, at step 605, the method 600 comprises receiving a notification of completion of the priority activity from the at least one second network. Thereafter, at step 607, the method comprises allowing the first network to resume allocation of physical channel resources to the first SIM upon receiving the notification.

As shown in FIG. 7 (e.g., at preamble step), SIM A, SIM B and SIM C registration procedures and corresponding ANC (200) registration procedures from respective gNB s may be already completed (e.g., prior to step 1 of FIG. 7). In some aspects, the preamble step of FIG. 7 may refer to, or include aspects of, step 601a of FIG. 6.

At Step 1, gNB A triggers a Subscription request to ANC (200), for getting notified with ongoing activities of SIM B and SIM C. The Subscription request may include ANCSIs of SIM B and SIM C. At Step 2, ANC (200) prepares to monitor the ongoing activities of ANCSIs that are subscribed. At Step 3, SIM A moves to PS connected mode and data transfer is ongoing. At Step 4, upon detecting SIM A's movement to PS Connected mode, gNB A triggers an Activity Update message to ANC (200), indicating PS data transfer is ongoing. In some cases, one or more aspects of steps 1-4 may refer to steps 601b-601c of FIG. 6.

At Step 5, SIM B initiates a high priority activity (e.g., such as a Call, Short Message Service (SMS), Supplementary services (SS), Non Access Stratum (NAS) signaling or Access Stratum (AS) signaling, etc. When SIM B initiates the high priority activity, the Radio Frequency Integrated Circuit (RFIC) may be reserved for SIM B dedicatedly (e.g., until end of the high priority activity). As such, the PS data on SIM A may be paused due to the high priority activity, without any explicit indication to gNB A from SIM A. At step 6, gNB B may trigger an Activity Update message to ANC (200) indicating the high priority signaling of SIM B. At Step 7, the Activity Information indicating high priority signaling is informed to gNB A, as gNB A had subscribed for SIM B's activities. At Step 8, gNB A may decide to scale down/hold the resource allocation to SIM A, as SIM A's PS data activity is paused in MSMS UE. In some cases, one or more aspects of steps 5-8 may refer to steps 601-603 of FIG. 6.

At Step 9, the ongoing high priority activity from SIM B is ended. In some cases, one or more aspects of step 9 may refers to step 605 of FIG. 6.

At Step 10 and Step 11, gNB B propagates the activity information indicating idle entry of SIM B to gNB A through ANC. At Step 12, gNB A scale up/resumes the resource allocation to SIM A. In some cases, one or more aspects of steps 10-12 may refer to step 607 of FIG. 6.

Thus, gNBs intelligently scales down/holds the physical channel resources (PCR) allocations, based on the information from ANC (200) that the corresponding SIM have paused the PS Data transfer due to high priority activity. Such may reduce PCR wastage (e.g., unnecessary overhead, inefficient resource utilization, etc.) in network end, without additional signaling overhead.

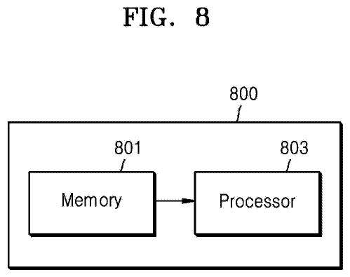

FIG. 8 illustrates a block diagram of an example system providing communication between a multi-SIM UE and a plurality of networks, in accordance with one or more aspects of the present disclosure. In an example embodiment, the system 800 may comprise a memory 801 and a processor 803. The processor 803 is coupled to the memory 801. In one or more aspects of the present disclosure, the processor 803 may be configured to perform one or more aspects of the techniques described herein (e.g., with reference to methods and systems described with respect to FIGS. 3-7). Moreover, the processor 803 may also be configured to perform the techniques discussed above.

It should be noted that the system 800 may be a part of the ANC. In an alternate embodiment, the ANC (200) may perform the functions of the system 800. In an example embodiment, the ANC (200) may be connected to the plurality of networks (e.g., gNB A, gNB B, gNB C) or may be a part of each or any of the plurality of networks (e.g., gNB A, gNB B, gNB C).

Software may include code to implement aspects of the present disclosure. Software may be stored in a non-transitory computer-readable medium or memory 801 (e.g., such as system memory or other memory). In some cases, the software may not be directly executable by the processor 803 but may cause a computer (e.g., when compiled and executed) to perform functions described herein.

In an exemplary embodiment, the processor 803 may be a single processing unit or a number of units, all of which could include multiple computing units. The processor 803 may be implemented as one or more microprocessors, microcomputers, microcontrollers, digital signal processors, central processing units, state machines, logic circuitries, and/or any devices that manipulate signals based on operational instructions. Among other capabilities, the processor 803 may be configured to fetch and execute computer-readable instructions and data stored in the memory. The processor 803 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory 801, 901. The predefined operating rule or artificial intelligence model is provided through training or learning.

In an example embodiment, the memory 801 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In some examples, memory 801 is used to store computer-readable, computer-executable software including instructions that, when executed, cause a processor 803 to perform various functions described herein. In some cases, the memory 801 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory 801 store information in the form of a logical state.

Further, it can be noted that the RM database (207), SM (211), UE state manager (209) can be a part of a same database or can be different databases. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with database controller. In other cases, database controller may operate automatically without user interaction.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for communication between a multiple subscriber identity module (SIM) user equipment (UE) and a plurality of networks, the method comprising:
notifying at least one second SIM to hold decoding of paging data associated with a paging channel monitoring request, wherein the at least one second SIM is registered with at least one second network of the plurality of networks;
receiving an indication associated with the paging channel monitoring request from the at least one second network;
transmitting the indication associated with the paging channel monitoring request to a first SIM registered with a first network of the plurality of networks, wherein the indication associated with the paging channel monitoring request is meant for the at least one second SIM; and
allowing the first SIM to instruct the at least one second SIM to resume decoding of the paging data.

2. The method of claim 1, wherein:
the at least one second SIM holds the decoding of paging data, upon completion of a mobile terminating procedure associated with the paging data.

3. The method of claim 1, wherein prior to notifying the at least one second SIM to hold decoding of the paging data, the method further comprises:
registering the first SIM and the at least one second SIM;
receiving a request from the first SIM to provide the indication associated with the paging channel monitoring request meant for the at least one second SIM; and
registering the first SIM in a database to indicate the paging channel monitoring request meant for the at least one second SIM.

4. The method of claim 1, further comprising:
assigning a unique identity to each of a plurality of SIMs, the plurality of SIMs including at least the first SIM and the at least one second SIM; and
storing the unique identity assigned to each of the plurality of SIMs.

5. The method of claim 1, further comprising:
monitoring a state of each of a plurality of SIMs, the plurality of SIMs including at least the first SIM and the at least one second SIM; and
storing state information related to the state of each of the plurality of SIMs.

6. A method for communication between a multiple subscriber identity module (SIM) user equipment (UE) and a plurality of networks, the method comprising:
receiving a notification of priority activity from at least one second network of the plurality of networks, wherein the at least one second network is associated with at least one second SIM;
allowing a first network to hold allocation of physical channel resources to the first SIM based on the notification, wherein the first network is associated with a first SIM;
receiving a notification of completion of the priority activity from the at least one second network; and
allowing the first network to resume allocation of physical channel resources to the first SIM upon receiving the notification of completion of the priority activity.

7. The method of claim 6, wherein prior to allowing the first network to hold allocation of physical channel resources, the method further comprises:
transmitting the notification of priority activity to the first network of the plurality of networks.

8. The method of claim 6, wherein prior to receiving the notification of the priority activity from the at least one second network, the method further comprises:
registering the first SIM and the at least one second SIM;
receiving a subscription request from the first network associated with the first SIM to provide the notification of priority activity of the at least one second SIM; and
accepting the subscription request.

9. The method of claim 6, further comprising:
assigning a unique identity to each of a plurality of SIMs, the plurality of SIMs including at least the first SIM and the at least one second SIM; and
storing the unique identity assigned to each of the plurality of SIMs.

10. The method of claim 6, further comprising:
monitoring a state of each of a plurality of SIMs, the plurality of SIMs including at least the first SIM and the at least one second SIM; and
storing state information related to the state of each of the plurality of SIMs.

11. A system for communication between a multiple subscriber identity module (SIM) user equipment (UE) and a plurality of networks, the system comprises:
a memory; and
a processor coupled to the memory, the processor is configured to:
notify at least one second SIM to hold decoding of paging data associated with a paging channel monitoring request, wherein the at least one second SIM is registered with at least one second network of the plurality of networks;
receive an indication associated with the paging channel monitoring request from the at least one second network;
transmit the indication associated with the paging channel monitoring request to a first SIM registered with a first network of the plurality of networks, wherein the indication associated with the paging channel monitoring request is meant for the at least one second SIM; and
allow the first SIM to instruct the at least one second SIM to resume decoding of the paging data.

12. The system of claim 11, wherein: the at least one second SIM holds decoding of paging data, upon completion of a mobile terminating procedure associated with the paging data.

13. The system of claim 11, wherein prior to notifying the at least one second SIM to hold decoding of the paging data, the processor is further configured to:
register the first SIM and the at least one second SIM;
receive a request from the first SIM to provide the indication associated with the paging channel monitoring request meant for the at least one second SIM; and
register the first SIM in a database to indicate the paging channel monitoring request meant for the at least one second SIM.

14. The system of claim 11, wherein the processor is further configured to:
assign a unique identity to each of a plurality of SIMs, the plurality of SIMs including at least the first SIM and the at least one second SIM; and
store the unique identity assigned to each of the plurality of SIMs.

15. The system of claim 11, wherein the processor is further configured to:
monitor a state of each of a plurality of SIMs, the plurality of SIMs including at least the first SIM and the at least one second SIM; and
store state information related to the state of each of the plurality of SIMs.

16-20. (canceled)

21. The method of claim 1, wherein:
holding decoding of paging data associated with a paging channel monitoring request including at least one of cancelling decoding of paging data, pausing decoding of paging data and delaying decoding of paging data.

22. The method of claim 4, wherein:
The first unique ID assigned to the first SIM and the at least one second unique ID assigned to the at least one second SIM are an Access Network Coordinator Subscriber Identity (ANCSI),
wherein the first unique ID is parent-ANCSI, and the at least one second unique ID is linked-ANCSI.

23. The method of claim 22, wherein transmitting the indication associated with the paging channel monitoring request to a first SIM registered with a first network of the plurality of networks further comprising:
identifying the first network based on the first unique ID.

24. The system of claim 11, wherein:
holding decoding of paging data associated with a paging channel monitoring request including at least one of cancelling decoding of paging data, pausing decoding of paging data and delaying decoding of paging data.

25. The system of claim 14,
wherein the first unique ID assigned to the first SIM and the at least one second unique ID assigned to the at least one second SIM are an Access Network Coordinator Subscriber Identity (ANCSI),
wherein the first unique ID is parent-ANCSI, and the at least one second unique ID is linked-ANCSI,
wherein the processor is configured to identify the first network based on the first unique ID.
